(19) United States
(12) Patent Application Publication
(10) Pub. No.: US 2014/0248814 A1
(43) Pub. Date: Sep. 4, 2014

(54) COMPOSITE FLAME BARRIER

(71) Applicant: Zoltek Companies, Inc., St. Louis, MO (US)

(72) Inventor: Alan Handermann, Asheville, NC (US)

(21) Appl. No.: 14/348,731

(22) PCT Filed: Oct. 5, 2012
(86) PCT No.: PCT/US2012/058838

§ 371 Date: Mar. 31, 2014

Related U.S. Application Data
(60) Provisional application No. 61/543,892, filed on Oct. 6, 2011.
(60) Provisional application No. 61/593,508, filed on Feb. 1, 2012.

(51) Int. Cl. A62C 2/06; B32B 5/08

(52) U.S. Cl. CPC A62C 2/06; B32B 5/08
USPC 442/321; 442/320; 442/324; 442/326

(57) ABSTRACT

A composite flame barrier includes a woven or nonwoven fiber sheet material including flame resistant fibers of oxidized polyacrylonitrile; a mineral hydrate material at least partially embedded within the fiber sheet material. The fiber sheet material may be covered on one or two sides with an outer laminar material. The composite flame barrier is particularly useful in fire-rated wall assemblies, especially those designed to provide two, three and four hour fire-ratings, when tested according to ASTM E-119 or similar testing methods and standards.

### TECHNICAL FIELD

The present invention is directed to a composite flame barrier, primarily for use in fire-rated wall assemblies, especially those designed to provide two, three and four hour fire-ratings, when tested according to ASTM E-119 or similar testing methods and standards.

### BACKGROUND

Fire-rated wall construction assemblies are commonly used in the construction industry. Such assemblies are aimed at preventing fire, heat, and smoke from traveling from one section of a building to another. The assemblies often incorporate the use of some sort of fire-retardant material which substantially blocks the path of the fire, heat, and smoke for at least some period of time. The fire-retardant material may include fibers or fibrous fabrics, the fibers typically made of ceramic material.

### SUMMARY

The composite flame barrier of the present invention includes a flame resistant fiber mineral hydrate composite that is lightweight, handleable and easy to install in construction projects that require fire-rated wall assemblies. The composite flame barrier provides more architectural design freedom by allowing thinner, easier to form wall assemblies, while still meeting the fire-rating test requirements.

The present invention provides a composite flame barrier which, when tested according to standard flame resistance test methods such as American Standard Testing Method E-119, allows for longer fire-rated wall installations with fewer gypsum wallboard layers, less installation labor time and thinner wall construction assemblies. The composite flame barrier provides a strong fire resistant layer and also slows down the transmission of heat by exhibiting a significant endothermic cooling effect, when the mineral hydrate materials release their chemically bound water.

Although the contemplated use of the composite flame barrier of the present invention includes a higher fire-rated wall assembly, with thinner and lighter weight construction materials, it is to be understood that other end uses are intended where the endothermic cooling effect of the mineral hydrate materials, embedded within the flame resistant sheet material, can provide additional heat and flame protection by slowing down heat transmission. Such other uses for the composite flame barrier presently disclosed include, for example, fire protection for cable trays, fuel lines, structural steel, cable bundles, equipment shrouds, support members, electrical panels, medical gas boxes and elevator call boxes.

In accordance with a first aspect of the present invention, there is provided a composite flame barrier that includes a fiber sheet material including oxidized polyacrylonitrile (OPAN) flame resistant fibers, the fiber sheet material having first and second major surfaces; and a mineral hydrate material at least partially embedded within the fiber sheet material.

In one embodiment, the fiber sheet material of the composite flame barrier further includes flame resistant fibers of a second type. The second type of flame resistant fibers may be chosen from among meta-aramids, para-aramids, poly(diphenylether para-aramid), polybenzimidazole, polyimides, polyamideimides, novoloids, poly(p-phenylene benzobisoxazoles), poly(p-phenylene benzothiazoles), flame retardant viscose rayon, polyetheretherketones, polyketones, polyetherimides, and combinations thereof.

In one embodiment, the fiber sheet material of the composite flame barrier further includes high temperature reinforcing fibers chosen from among glass fiber, mineral fiber, ceramic fiber, carbon fiber, stainless steel fiber and combinations thereof.

In one embodiment, the composite flame barrier further includes a reinforcing layer overlying or underlying the fiber sheet material.

The mineral hydrate material may be chosen from among aluminum potassium sulfate dodecahydrate, magnesium sulfate heptahydrate, magnesium chloride hexahydrate, sodium tetraborate decahydrate and combinations thereof.

In one embodiment, the fiber sheet material of the composite flame barrier further includes a low temperature resistant fiber type chosen from among wood pulp types, hemps, flax, cottons, wools, nylons, polyesters, polyolefins, rayons, acrylics, silks, mohair, cellulose acetate, polylactides, lyocell, and combinations thereof.

In one embodiment, the fiber sheet material is a woven or nonwoven fabric.

In one embodiment, the fiber sheet material is a nonwoven, wet laid mat. In another embodiment, the fiber sheet material is a nonwoven air laid mat.

In one embodiment, the fiber sheet material is corrugated.

In one embodiment, the composite flame barrier further includes an outer laminar material overlying or underlying at least one of the major surfaces of the fiber sheet material.

In one embodiment, the outer laminar material is coated paper.

In another embodiment, the outer laminar material is polymeric film. The polymeric film may be chosen from among polyesters, polyethylenes, polypropylenes, polyvinyl chlorides, polyvinyl alcohols and combinations thereof.

In yet another embodiment, the outer laminar material is metal foil.

In one embodiment, the composite flame barrier further includes a binding agent for the mineral hydrate. The binding agent may be chosen from among water soluble binders, low-melt adhesives, low-melt polymeric films and combinations thereof.

The composite flame barrier may have a fire rating of 1 hr, 1.5 hr, 2 hr, 2.5 hr, 3 hr and 4 hr when tested according to ASTM E-119.

In accordance with a second aspect of the invention, there is provided a gypsum wallboard installation that includes a composite flame barrier that includes a fiber sheet material including oxidized polyacrylonitrile flame resistant fibers, the fiber sheet material having first and second major surfaces; and a mineral hydrate material at least partially embedded within the fiber sheet material.

### BRIEF DESCRIPTION OF THE DRAWINGS

FIG. 1 is a partial cross-sectional view of an embodiment of the composite flame barrier according to the present invention.

FIG. 2 is a partial cross-sectional view of an embodiment of the composite flame barrier that includes an outer laminar layer underlying the fiber sheet material in accordance with the present invention.

FIG. 3 is a partial cross-sectional view of an embodiment of the composite flame barrier that includes a reinforcement layer in accordance with the present invention.

FIG. 4 is a partial cross-sectional view of an embodiment of the composite flame barrier that includes an outer laminar layer overlying and underlying the fiber sheet material in accordance with the present invention.

FIG. 5 is a partial cross-sectional view of an embodiment of the composite flame barrier that includes two OPAN fiber containing sheets and an outer laminar layer.

FIG. 6 is a partial cross-sectional view of an embodiment of the composite flame barrier that includes a reinforcement layer between two OPAN fiber containing sheets in accordance with the present invention.

FIG. 7 is a partial cross-sectional view of an embodiment of the composite flame barrier that includes a corrugated OPAN fiber containing sheet between two outer layers.

### DETAILED DESCRIPTION

The present invention is directed to a composite flame barrier that includes a fiber sheet material including oxidized polyacrylonitrile (OPAN) flame resistant fibers, the fiber sheet material having first and second major surfaces; and a mineral hydrate material at least partially embedded within the fiber sheet material.

As used herein, the term “fiber sheet material” is intended to include woven and nonwoven fabrics and fibrous mats.

The term “mineral hydrate” refers to mineral crystals containing water molecules combined in a definite ratio as an integral part of the crystal.

The term “overlies” and cognate terms such as “overlying” and the like, when referring to the relationship of one or a first layer relative to another or a second layer, refers to the fact that the first layer partially or completely lies over the second layer. The first layer overlying the second layer may or may not be in contact with the second layer. For example, one or more additional layers may be positioned between the first layer and the second layer. The term “underlies” and cognate terms such as “underlying” and the like have similar meanings except that the first layer partially or completely lies under, rather than over, the second layer.

The term “outer” refers to the position of a layer as being farther from the center of the composite assembly, but does not necessarily mean such layer is the outermost layer.

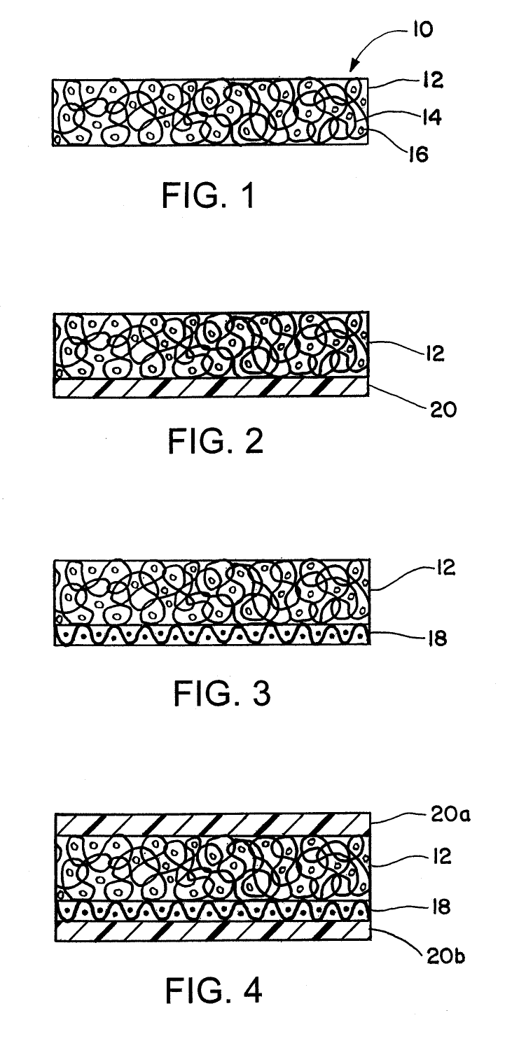

Referring to FIG. 1, in one embodiment the composite flame barrier 10 includes a fiber sheet material 12 constructed of OPAN fibers 14 and mineral hydrate particles 16 embedded within the fiber sheet material 12.

A particularly preferred OPAN fiber is that which is commercially available under the trade name PYRON®from Zoltek Corporation.

The fiber sheet material 12 may be a fabric layer or fiber mat that is woven or nonwoven and may be made of 100% by weight of oxidized polyacrylonitrile. Alternatively, the fiber sheet material may include flame resistant fibers of a second type. Examples of other flame resistant fibers that can be incorporated into the fiber sheet material 12 include meta-aramids such as poly(m-phenylene isophthalamide), for example, those sold under the trade names NOMEX by E. I. Du Pont de Nemours and Co., TEIJINCONEX by Teijin Limited, ARAMID 1313 by Guangdong Charming Chemical Co. Ltd., etc.; para-aramids such as poly(p-phenylene terephthalamide), for example, that sold under the trade name KEVLAR by E. I. Du Pont de Nemours and Co., poly(diphenylether para-aramid), for example, that sold under the trade name TECHNORA by Teijin Limited, and those sold under the trade name TWARON by Teijin Limited, etc.; polybenzimidazole such as that sold under the trade name PBI by PBI Performance Products, Inc.; polyimides, for example, those sold under the trade names P-84 by Evonik Industries; polyamideimides, for example, that sold under the trade name KERMEL by Kermel; novoloids, for example, phenol-formaldehyde novolac, that sold under the trade name KYNOL by Gun Ei Chemical Industry Co.; poly (p-phenylene benzobisoxazole) (PBO), for example, that sold under the trade name ZYLON by Toyobo Co.; poly (p-phenylene benzothiazoles) (PBT); polyphenylene sulfide (PPS), for example, those sold under the trade names RYTON by Chevron Phillips Chemical Company LLC, TORAY PPS by Toray Industries Inc., FORTRON by Kureha Chemical Industry Co. and PROCON by Toyobo Co.; flame retardant viscose rayons, for example, those sold under the trade names LENZING FR by Lenzing A.G. and AVILON by Avilon Oy Finland; polyetheretherketones (PEEK), for example, that sold under the trade name ZYEX by Zyex Ltd.; polyketones (PEK); polyetherimides (PEI), for example, that sold under the trade name ULTEM by Fiber Innovation Technologies Inc., and fiber combinations thereof.

The composite flame barrier may include high temperature reinforcing fibers to impart additional mechanical strength to the composite flame barrier. For example, the composite flame barrier can also include glass fibers, mineral fibers such as basalts, for example, those sold under the trade name BASFIBER® by Kamenny Vek, basalt fiber by Technobasalt-Invest LLC, basalt fiber by Sudaglass Fiber Technology, etc.; ceramic fibers, for example, those sold under the trade name BELCOTEX® by BelChem, CERATEX® by Mineral Seal Corporation, FIBERFRAX® by Unifrax I LLC, KAOWOOL® by Thermal Ceramics Inc., etc.; carbon fibers, stainless steel fibers or other similar high temperature reinforcing fibers. The high temperature reinforcing fibers may be incorporated into the nonwoven or woven fiber sheet material. Alternatively, the high temperature reinforcing fibers may be provided in a separate reinforcement layer within the composite assembly.

Referring to FIG. 2, the composite flame barrier may include an outer laminar layer 20 overlying or underlying fiber sheet material 12. The laminar layer 20 may be a coated paper, a polymeric film, or a metallic foil. Examples of useful polymeric films include polyesters, polyethylenes, polypropylenes, polyvinyl chlorides, polyvinyl alcohols and combinations thereof. The laminar layer may be bonded to one or both sides of the fiber sheet material 12, for example, by lamination.

Referring to FIG. 3, the composite flame barrier may include a reinforcing layer 18 overlying or underlying fiber sheet material 12. The reinforcing layer 18 may be a woven high temperature reinforcement material constructed of glass; ceramic; carbon; mineral, such as basalt; metal, such as stainless steel; polymer, such as the flame resistant polymers listed above; and combinations of two or more thereof. In one embodiment, the reinforcing layer 18 is a high strength fiberglass scrim.

For applications that do not require the high flame resistance that results with using a fiber sheet material of 100% oxidized polyacrylonitrile fiber, the composite flame barrier can also include low temperature synthetic or natural fibers within the fiber sheet material 12. Such low temperature fibers may be selected from a variety of different types of either natural or synthetic fibers. Examples of low temperature fibers include wood pulp types, hemps, flax, cottons, wools, nylons, polyesters, polyolefins, rayons, acrylics, silks, mohair, cellulose acetate, polylactides, lyocell, and combinations thereof.

The hydrated mineral 16 that is at least partially embedded in the fiber sheet material imparts additional fire resistance to the composite flame barrier. The hydrated mineral provides an endothermic water release under heating and burning conditions to provide additional heat and flame protection by slowing down heat transmission. Examples of suitable mineral hydrates include aluminum trihydrate, aluminum potassium sulfate dodecahydrate, magnesium hydroxide, magnesium bromate hexahydrate, magnesium sulfate heptahydrate, magnesium iodate tetrahydrate, magnesium antimonate hydrate, magnesium chloride hexahydrate, calcium ditartrate tetrahydrate, calcium chromate dihydrate, sodium tetraborate decahydrate, sodium thiosulfate pentahydrate, sodium pyrophosphate hydrate, potassium ruthenate hydrate, potassium sodium tartrate tetrahydrate, zinc iodate dihydrate, zinc sulfate heptahydrate, zinc phenol sulfonate octahydrate, manganese chloride tetrahydrate, cobalt orthophosphate octahydrate, beryllium oxalate trihydrate, zirconium chloride octahydrate, thorium hypo phosphate hydrate, thallium sulfate heptahydrate, and dysprosium sulfate octahydrate. Particularly useful mineral hydrates are aluminum potassium sulfate dodecahydrate, magnesium sulfate heptahydrate, magnesium chloride hexahydrate, and sodium tetraborate decahydrate.

The mineral hydrate material 16 may be incorporated within the fiber sheet material 12 by saturating the fiber sheet material with a mineral hydrate water solution and then at least partially drying the saturated fiber sheet material. The mineral hydrate water solution may include a water soluble binder to facilitate binding of the mineral hydrate to the fibers of the fiber sheet material. Alternatively, the mineral hydrate material may be applied to the surface of the fiber sheet material in the form of crystals or powders together with a low-melt binder, adhesive or film. Heat and pressure may be applied to at least partially embed the crystals or powder particles within the fiber sheet material.

Referring to FIG. 4, the fiber sheet material 12 of the composite flame barrier may be covered on one or both sides with a laminar material 20a, 20b. The laminar layer 20a, 20b may be a coated paper, a polymeric film, or a metallic foil. The laminar layer(s) may be bonded to one or both sides of the fiber sheet material 12, for example, by lamination. If a reinforcement layer 18 is present, a laminar layer 20b may be bonded to an outer surface of the reinforcement layer as illustrated in FIG. 3. In one embodiment of the invention, the composite flame barrier includes a single 2-50 ounce per square yard (67.8-1695 g/m²) nonwoven or woven fabric of PYRON® oxidized polyacrylonitrile fiber, or preferably a single 4-30 ounce per square yard (135.6-1017 g/m²) nonwoven fabric of PYRON® oxidized polyacrylonitrile fiber; which has been saturated in a water solution of a mineral hydrate, combined with a small amount of water soluble binder (such as polyvinyl alcohol, etc.), and sent through nip rollers, partially dried and sealed and laminated to a layer of coated paper, polymeric film or metallic foil. The mineral hydrate material may be chosen from among aluminum potassium sulfate dodecahydrate, magnesium sulfate heptahydrate, magnesium chloride hexahydrate, sodium tetraborate decahydrate, combinations thereof, and any other mineral hydrate.

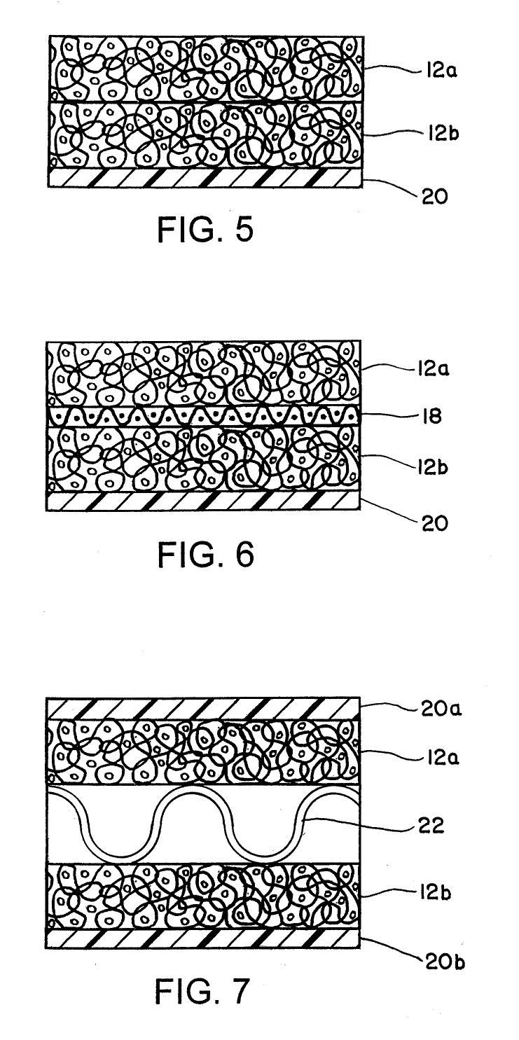

Referring to FIG. 5, in another embodiment of the invention, the composite flame barrier 10 includes two fiber sheet material layers 12a, 12b adjacent to each other. A laminar layer 20 may be bonded to a major outer surface of one or both fiber sheet material layers 12a, 12b. For example, the composite flame barrier may include two 1-25 ounce per square yard (33.9-847.5 g/m²) nonwoven or woven fabrics of PYRON® oxidized polyacrylonitrile fiber, or preferably two 2-15 ounce per square yard (67.8-508.5 g/m²) nonwoven fabrics of PYRON® oxidized polyacrylonitrile fiber; in which mineral hydrate powder or crystal is embedded within the two fabric layers, with or without a low-melt adhesive powder or film, and laminated to a layer of coated paper, polymeric film or metallic foil.

Referring to FIG. 6, in another embodiment of the invention, the composite flame barrier 10 includes two fiber sheet material layers 12a, 12b with a reinforcing layer 18 arranged between the two fiber sheet material layers 12a, 12b. A laminar layer 20 may be bonded to a major outer surface of one or both fiber sheet material layers 12a, 12b. For example, the composite flame barrier may include two 1 to 25 ounce per square yard (33.9-847.5 g/m²) nonwoven or woven fabrics of PYRON® oxidized polyacrylonitrile fiber, or preferably two 2-15 ounce per square yard (67.8-508.5 g/m²) nonwoven fabrics of PYRON® oxidized polyacrylonitrile fiber; in which mineral hydrate powder or crystal is embedded within the two fabric layers, along with a 0.5-5.0 ounce per square yard (17.0-169.5 g/m²) fiberglass or other high strength scrim, with or without a low-melt adhesive powder or film, and laminated to a layer of coated paper, polymeric film or metallic foil.

In the manufacture of wet-laid mats, fibers are typically dispersed in an aqueous solution that contains a binder as well as dispersants, viscosity modifiers, defoaming agents, and/or other chemical agents, and agitated to form a slurry. The fibers located in the slurry are deposited onto a screen where water is removed to form a mat. The mat may be dried in an oven.

In the manufacture of air-laid mats, water is not used as the carrying medium for the fibers. The fibers can be blended with additives and/or other types of fibers in a high velocity air stream and transferred by air stream to a sheet former where the fibers are formed into a mat. A binder resin is typically applied to the mat or added to the fibers prior to mat formation. The binder resin may be in the form of a resin powder, flake, granule, foam or liquid spray.

In one embodiment of the invention, the composite flame barrier includes a single 0.5-16 ounce per square yard (17-542 g/m²) sheet of PYRON® oxidized polyacrylonitrile fiber, or preferably a single 1-10 ounce per square yard (34-339 g/m²) sheet of PYRON® oxidized polyacrylonitrile fiber; which has been saturated in a water solution of a mineral hydrate, combined with a small amount of water soluble binder (such as polyvinyl alcohol, etc.), and sent through nip rollers, partially dried and sealed and laminated between two layers of coated paper or polymeric film. The mineral hydrate material may be chosen from among aluminum potassium sulfate dodecahydrate, magnesium sulfate heptahydrate, magnesium chloride hexahydrate, sodium tetraborate decahydrate, combinations thereof, and any other mineral hydrate.

In another embodiment of the invention, the composite flame barrier is formed in-situ, during the manufacture of a single 0.5-16 ounce per square yard (17-542 g/m²) wet lay operation where a sheet consisting of PYRON® oxidized polyacrylonitrile fiber, mineral hydrates and a small amount of water soluble binder (such as polyvinyl alcohol, etc.) is formed on a papermaking machine and then calendared to remove excess solution, partially dried and laminated to one layer of coated paper, polymeric film or metal foil. The mineral hydrate material may be chosen from among aluminum potassium sulfate dodecahydrate, magnesium sulfate heptahydrate, magnesium chloride hexahydrate, sodium tetraborate decahydrate, aluminum trihydrate or combinations thereof, and any other mineral hydrate.

In another embodiment of the invention, the composite flame barrier includes two 0.5-8 ounce per square yard (17.0-271 g/m²) sheets of PYRON® oxidized polyacrylonitrile fiber, or preferably two 1-5 ounce per square yard (33.8-169.5 g/m²) sheets of PYRON® oxidized polyacrylonitrile fiber; in which mineral hydrate powder or crystal is embedded within the two sheets, with or without a low-melt adhesive powder or film, and sealed and laminated between two layers of coated paper or polymeric film.

In yet another embodiment of the invention, the composite flame barrier includes two 0.5 to 8 ounce per square yard (17.0-271 g/m²) sheets of PYRON® oxidized polyacrylonitrile fiber, or preferably two 1-5 ounce per square yard (33.8-169.5 g/m²) sheets of PYRON® oxidized polyacrylonitrile fiber; in which mineral hydrate powder or crystal is embedded within the two sheets, along with a 0.5-5.0 ounce per square yard (17.0-169.5 g/m²) fiberglass or other high strength scrim, with or without a low-melt adhesive powder or film, and sealed and laminated between two layers of coated paper or polymeric film.

Corrugated cardboard may be manufactured by corrugating a first fiber sheet by passing the sheet through corrugating rollers. The corrugated sheet is then bonded between two outer liners with a bonding agent. The bonding agent may be cured by passing the cardboard over heated rollers. The first fiber sheet may be impregnated with mineral hydrate prior to corrugation or prior to adhering the outer liners to the inner corrugated sheet. Alternatively, the mineral hydrate may be deposited within the corrugations of the interior fiber sheet. Optionally, the outer liners may also be impregnated with mineral hydrate. The first fiber sheet may include OPAN fibers with or without additional fibers of a second type. The outer liners may be constructed of the same material as the inner first fiber sheet, or may be constructed of fibers of a different composition.

Referring to FIG. 7, in one embodiment of the invention, a composite flame barrier 10 includes an inner corrugated fiber sheet material 22 bonded to a fiber sheet material layer 12a, 12b on each side of the inner corrugated layer. A laminar layer 20a, 20b may be bonded to a major outer surface of one or both fiber sheet material layers 12a, 12b. For example, the composite flame barrier may include three 0.5 to 8 ounce per square yard (17.0-271 g/m²) sheets of PYRON® oxidized polyacrylonitrile fiber, or preferably three 1-5 ounce per square yard (33.8-169.5 g/m²) sheets of PYRON® oxidized polyacrylonitrile fiber; in which mineral hydrate has been saturated in a water solution, combined with a small amount of water soluble binder (such as polyvinyl alcohol, etc.), and subsequently formed into a corrugated cardboard structure, with or without additional mineral hydrate embedded with the corrugations of the cardboard structure. The entire assembly may then be laminated between two layers of coated paper or polymeric film.

The following non-limiting examples are set forth to demonstrate the present invention.

### EXAMPLE I

Composite Flame Barrier

A composite flame barrier is made by forming two needlepunched nonwoven felts of PYRON® oxidized polyacrylonitrile staple fibers. A powder applicator is used to evenly distribute a blend of magnesium sulfate heptahydrate powder and a low-melt copolyester powder onto the surface of one of the PYRON® needlepunched felts, and then the two PYRON® nonwoven felts are bonded together between two coated papers by processing through a lamination oven, embedding the mineral hydrate and laminating the coated paper layers to the outside of the nonwoven felt to form the composite flame barrier.

### EXAMPLE II

Composite Flame Barrier

A composite flame barrier is made by forming a needlepunched nonwoven felt of PYRON® oxidized polyacrylonitrile staple fibers. The needlepunched felt is saturated in a heated solution of magnesium sulfate heptahydrate containing a water soluble polyvinyl alcohol binder and then sent through nip rollers to remove excess solution. The saturated nonwoven felt is partially dried and then two coated papers are bonded to the felt with a low-melt adhesive film in a lamination oven, embedding the mineral hydrate within the nonwoven and laminating the coated paper layers to the outside of the nonwoven felt to form the composite flame barrier.

### EXAMPLE III

Composite Flame Barrier

A composite flame barrier is made by forming two needlepunched nonwoven felts of PYRON® oxidized polyacrylonitrile staple fibers. A powder applicator is used to evenly distribute a blend of magnesium sulfate heptahydrate powder and a low-melt copolyester powder onto the surface of one of the PYRON® needlepunched felts. A fiberglass scrim is also brought in-between the felts and the entire assembly is bonded together between two coated papers by processing through a lamination oven, embedding the fiberglass scrim, the mineral hydrate and laminating the coated paper layers to the outside of the nonwoven felt to form the composite flame barrier.

### EXAMPLE IV

Composite Flame Barrier

A composite flame barrier is made by forming a nonwoven felt of a PYRON® oxidized polyacrylonitrile staple fibers which has been needled into a fiberglass scrim. The needle-punched, scrim-containing felt is saturated in a heated solution of magnesium sulfate heptahydrate, containing a water soluble polyvinyl alcohol binder, and then sent through nip rollers to remove excess solution. The saturated needlepunched, scrim containing, felt is partially dried and then two coated papers are bonded to the felt with a low-melt adhesive film in a lamination oven, embedding the mineral hydrate within the scrim containing nonwoven felt and laminating the coated paper layers to the outside of the felt to form the composite flame barrier.

### EXAMPLE V

Composite Flame Barrier

A composite flame barrier is made by forming two wet-laid sheets of PYRON® oxidized polyacrylonitrile staple fibers. A powder applicator is used to evenly distribute a blend of magnesium sulfate heptahydrate powder and a low-melt polyvinyl alcohol powder onto the surface of one of the PYRON® sheets, and then the two PYRON® sheets are bonded together between two coated papers by processing through a lamination oven, embedding the mineral hydrate and laminating the coated paper layers to the outside of the wet-laid sheet to form the composite flame barrier.

### EXAMPLE VI

Composite Flame Barrier

A composite flame barrier is made by forming a wet-laid sheet of PYRON® oxidized polyacrylonitrile staple fibers. The formed fiber sheet is saturated in a heated solution of magnesium sulfate heptahydrate containing a water soluble polyvinyl alcohol binder and then sent through nip rollers to remove excess solution. The saturated wet-laid sheet is partially dried and then two coated papers are bonded to the wet-laid sheet in a lamination oven, embedding the mineral hydrate within the wet-laid sheet and laminating the coated paper layers to the outside of the wet-laid sheet to form the composite flame barrier.

### EXAMPLE VII

Composite Flame Barrier

A composite flame barrier is made by forming, in-situ, a wet-laid sheet of PYRON® oxidized polyacrylonitrile staple fibers, aluminum trihydrate and water soluble polyvinyl alcohol binder directly on a wetlay paper machine and then calandering to remove excess solution. The saturated wet-laid sheet is then partially dried and a layer of coated paper is bonded to one-side of the wet-laid sheet in a lamination oven. In this case, the mineral hydrate is embedded within the wet-laid sheet, during the paper formation process and then it is laminated with a coated paper to one side of the wet-laid sheet to form the composite flame barrier.

### EXAMPLE VIII

Composite Flame Barrier

A composite flame barrier is made by forming a wet-laid sheet of PYRON® oxidized polyacrylonitrile staple fibers. The sheet is saturated in a heated solution of magnesium sulfate heptahydrate containing a water soluble polyvinyl alcohol binder and then sent through nip rollers to remove excess solution. The saturated wet-laid sheet is partially dried and a fiberglass scrim is also brought in and the entire assembly is bonded together between two coated papers by processing through a lamination oven, embedding the fiberglass scrim, the mineral hydrate and laminating the coated paper layers to the outside of the wet-laid sheet/fiberglass scrim combination to form the composite flame barrier.

### EXAMPLE IX

Composite Flame Barrier

A composite flame barrier is made by forming a wet-laid sheet of PYRON® oxidized polyacrylonitrile staple fibers. The three layers of formed sheet are saturated in heated solutions of magnesium sulfate heptahydrate containing a water soluble polyvinyl alcohol binder and then sent through nip rollers to remove excess solution. The center saturated wet-laid sheet, is partially dried and corrugated and then bonded between two saturated, partially dried wet-laid sheets to form a cardboard structure. Then two coated papers are bonded to the cardboard structure in a lamination oven, embedding the mineral hydrate within the wet-laid sheets of the cardboard and laminating the coated paper layers to the outside of the cardboard to form the composite flame barrier.

While the invention has been explained in relation to various embodiments, it is to be understood that various modifications thereof will be apparent to those skilled in the art upon reading the specification. The features of the various embodiments of the articles described herein may be combined within an article. Therefore, it is to be understood that the invention described herein is intended to cover such modifications as fall within the scope of the appended claims.

1-20. (canceled)

21. A composite flame barrier comprising:
at least two needlepunched nonwoven felts comprising oxidized polyacrylonitrile flame resistant fibers, each needlepunched nonwoven felt having an inner major surface and an outer major surface; and
a mineral hydrate material at least partially embedded within the at least two needlepunched nonwoven felts, wherein the mineral hydrate material is embedded into the needlepunched nonwoven felts without a low melt adhesive powder or film.

22. The composite flame barrier of claim 21, wherein at least one of the needlepunched nonwoven felts further comprises flame resistant fibers of a second type.

23. The composite flame barrier of claim 22 wherein the second type of flame resistant fibers are chosen from among meta-aramids, para-aramids, poly(diphenylether para-aramid), polybenzimidazole, polyimides, polyamideimides, novoloids, poly(p-phenylene benzobisoxazoles), poly(p-phenylene benzothiazoles), flame retardant viscose rayon, polyetheretherketones, polyketones, polyetherimides, and combinations thereof.

24. The composite flame barrier of claim 21, wherein at least one of the nonwoven needlepunched felts further comprises high temperature reinforcing fibers chosen from among glass fiber, mineral fiber, ceramic fiber, carbon fiber, stainless steel fiber and combinations thereof.

25. The composite flame barrier of claim 21, further comprising a reinforcing layer.

26. The composite flame barrier of claim 21, wherein the mineral hydrate material is chosen from among aluminum potassium sulfate dodecahydrate, magnesium sulfate heptahydrate, magnesium chloride hexahydrate, sodium tetraborate decahydrate and combinations thereof.

27. The composite flame barrier of claim 21, wherein at least one of the nonwoven needlepunched felts further comprises a low temperature resistant fiber type chosen from among wood pulp types, hemps, flax, cottons, wools, nylons, polyesters, polyolefins, rayons, acrylics, silks, mohair, cellulose acetate, polylactides, lyocell, and combinations thereof.

28. The composite flame barrier of claim 21, further comprising at least one outer laminar material overlying or underlying an outer major surface of at least one of the needlepunched nonwoven felts.

29. The composite flame barrier of claim 28, wherein the at least one outer laminar material comprises a polymeric film.

30. The composite flame barrier of claim 29 wherein the polymeric film is chosen from among polyesters, polyethylenes, polypropylenes, polyvinyl chlorides, polyvinyl alcohols and combinations thereof.

31. The composite flame barrier of claim 28, wherein the at least one outer laminar material comprises metal foil.

32. The composite flame barrier of claim 28, wherein the at least one outer laminar material comprises paper.

33. The composite flame barrier of claim 21 having a fire rating of 1 hr, 1.5 hr, 2 hr, 2.5 hr, 3 hr and 4 hr when tested according to ASTM E-119.

34. A gypsum wallboard installation comprising the composite flame barrier of claim 21.
